(19) United States
(12) Patent Application Publication
(10) Pub. No.: US 2021/0002895 A1
(43) Pub. Date: Jan. 7, 2021

(54) PANEL STRUCTURE AND METHOD FOR MANUFACTURING THE SAME

(71) Applicant: MITSUBISHI HEAVY INDUSTRIES, LTD., Tokyo (JP)

(72) Inventors: Kunihiro MORISHITA, Tokyo (JP); Naoya MATSUBARA, Tokyo (JP)

(21) Appl. No.: 16/788,942

(22) Filed: Feb. 12, 2020

(30) Foreign Application Priority Data
Jul. 5, 2019 (JP) 2019-125977

(51) Int. Cl. E04C 2/34; B21D 39/03; B32B 3/30; B32B 15/01

(52) U.S. Cl. CPC E04C 2/34; B21D 39/03; E04C 2/08; B32B 15/017; B32B 3/30

(57) ABSTRACT

The panel structure includes: a stiffened panel and a stiffening panel which is joined to the stiffened panel. The stiffening panel integrally has top end plate parts which are joined to a plate surface of the stiffened panel, a base part which is separated from the plate surface of the stiffened panel and faces the plate surface, and a plurality of pillar parts which connect the base part and the top end plate parts. One end part of each of the pillar parts is connected to the base part, another end part is connected to each of the top end plate parts, and a cross-sectional shape of each of the connecting parts a in direction from the one end part toward the other end part is bent or curved. Between the pillar parts neighboring each other, openings are formed.

### BACKGROUND OF THE INVENTION

### 1. Field of the Invention

The present disclosure relates to a panel structure and a method for manufacturing a panel structure.

### 2. Description of Related Art

A panel structure in which projections for enhancing out-of-plane rigidity are formed in one plate member and the projections of the plate member and another tabular plate member are joined has been proposed (for example, refer to Patent Literature 1).

In Patent Literature 1, a structure which includes a space-trussed metal plate and a planar metal plate is described. The space-trussed metal plate is molded by press working, and circular ribbed openings are provided at apices thereof. On the other hand, the planar metal plate is provided with projection parts molded by the press working. The projection parts are inserted and fitted into the ribbed openings and are enlarged and deformed toward the outside of a circumference, thereby tightly fixing the metal plate and the metal plate.

### CITATION LIST

### Patent Literature

Patent Literature 1: Japanese Unexamined Patent Application, Publication No. 2004-100326

However, the structure described in Patent Literature 1 is to support a light collecting device and a ventilation device, and it is not assumed that a large load is exerted thereon. In particular, since four pillar parts which are connected at the apices are formed each in a flat plate shape, and if a load is exerted on the structure, it is likely that these pillar parts are buckled.

In view of the circumstances described above, the present disclosure is made, and an object thereof is to provide a panel structure and a method for manufacturing a panel structure of which rigidity can be further enhanced.

### BRIEF SUMMARY OF THE INVENTION

In order to solve the above-mentioned problem, in a panel structure and a method for manufacturing a panel structure of the present disclosure, the below-described means are employed.

A panel structure according to one aspect of the present disclosure includes: a first panel; and a second panel being joined to the first panel, the second panel integrally has joining parts which are joined to a plate surface of the first panel, a base part which is separated from the plate surface of the first panel and faces the plate surface, and a plurality of connecting parts which connect the base part and the joining parts, one end part of each of the connecting parts is connected to the base part, another end part of each of the connecting parts is connected to each of the joining parts, and a cross-sectional shape of each of the connecting parts in a direction from the one end part toward the other end part is bent or curved, and between the connecting parts neighboring each other, openings are formed.

A method for manufacturing a panel structure according to one aspect of the present disclosure is a method for manufacturing a panel structure including: a first panel; and a second panel being joined to the first panel, in the panel structure, the second panel integrally has joining parts which are joined to a plate surface of the first panel, a base part which is separated from the plate surface of the first panel and faces the plate surface, and a plurality of connecting parts which connect the base part and the joining parts, one end part of each of the connecting parts is connected to the base part, another end part of each of the connecting parts is connected to each of the joining parts, and a cross-sectional shape of each of the connecting parts in a direction from the one end part toward the other end part is bent or curved, and between the connecting parts neighboring each other, openings are formed, the method including: an opening forming step of forming the openings on a tabular member; a press working step of subjecting the member having the openings formed in the opening forming step to press working and of molding the second panel; and a joining step of joining the joining parts of the second panel molded in the press working step and the plate surface of the first panel.

According to the present disclosure, rigidity of the whole panel structure can be further enhanced.

### BRIEF DESCRIPTION OF THE SEVERAL VIEWS OF THE DRAWINGS

FIG. 1 is a cutout perspective view illustrating a principal part of a panel structure according to one embodiment of the present disclosure;

FIG. 2 is a plan view illustrating a stiffening panel of the panel structure in FIG. 1;

FIG. 3 is a schematic plan view illustrating the principal part of the stiffening panel in FIG. 2 in an enlarged manner;

FIG. 4 is a cross-sectional view illustrating a portion, viewed along arrows IV-IV in FIG. 3;

FIG. 5 is a schematic side view illustrating the principal part of the stiffening panel in FIG. 2 in an enlarged manner;

FIG. 6 is a schematic perspective view illustrating a portion where a top panel plate of the stiffening panel in FIG. 3 and a pillar part are connected with each other;

FIG. 7 is a schematic plan view showing a method for manufacturing the stiffening panel in FIG. 2;

FIG. 8 is a diagram illustrating a modification of the stiffening panel shown in FIG. 3;

FIG. 9 is a diagram illustrating a modification of the portion shown in FIG. 4;

FIG. 10 is a diagram illustrating a modification of the portion shown in FIG. 4;

FIG. 11 is a cross-sectional view illustrating a modification of the stiffening panel shown in FIG. 5;

FIG. 12 is a cross-sectional view illustrating a modification of the stiffening panel shown in FIG. 5;

FIG. 13 is a diagram illustrating a modification of the stiffening panel shown in FIG. 3;

FIG. 14 is a schematic perspective view illustrating a portion where a top panel plate of the stiffening panel and pillar parts in FIG. 13 are connected with each other;

FIG. 15 is a diagram illustrating a modification of the stiffening panel shown in FIG. 3; and

FIG. 16 is a schematic perspective view illustrating a portion where a top panel plate of the stiffening panel and pillar parts in FIG. 15 are connected with each other.

### DETAILED DESCRIPTION OF THE INVENTION

Hereinafter, a panel structure and a method for manufacturing a panel structure according to an embodiment of the present disclosure will be described with reference to the accompanying drawings.

The panel structure 1 according to the present embodiment is applied to, for example, a wall member of a cylindrical tank having a large diameter, such as a fuel tank and an LNG tank. Note that the panel structure 1 may be applied to a member other than the wall member of the tank. For example, the panel structure 1 may be applied to a wall member of a silo or the like.

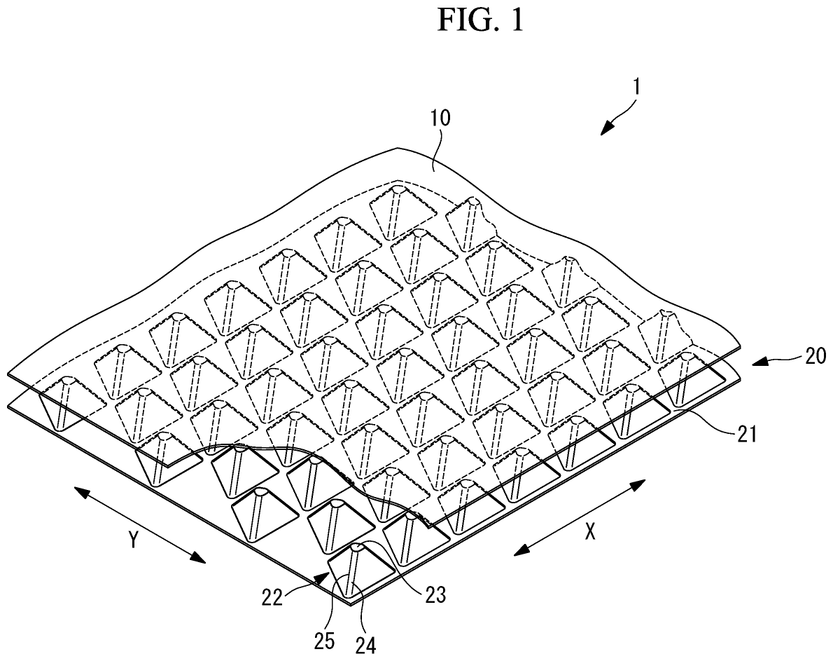

As shown in FIG. 1, the panel structure 1 includes a tabular stiffened panel (first panel) 10 and a stiffening panel (second panel) 20 which is joined to the stiffened panel 10 and stiffens the stiffened panel 10. The stiffened panel 10 and the stiffening panel 20 are formed of, for example, metal such as aluminum. Note that it is only required for a material of the stiffened panel 10 and the stiffening panel 20 to be metal and the material thereof is not limited to the aluminum.

The stiffening panel 20 integrally has a tabular base part 21 and a plurality of projection parts 22 which project from the base part 21 in a direction toward the stiffened panel 10. Each of the projection parts 22 is formed to be triangular pyramid trapezoidal shaped in a contour. Note that in the below description, a view in a case in which a plate surface of the stiffening panel 20 is viewed from a side of the stiffened panel 10 is referred to as a “planar view” and a view in a case in which the stiffening panel 20 is viewed from a direction intersecting a direction of the planar view is referred to as a “side view”.

The base part 21 is separated from one surface 10a (a surface on a side of the stiffening panel 20) of a plate surface of the stiffened panel 10. In addition, the base part 21 is disposed in such a way as to face the one surface 10a of the stiffened panel 10 substantially in parallel therewith. In addition, the base part 21 has marginal part 21b, each of which defines an outer end (a triangle of a lower end of the triangular pyramid trapezoid) of each of the projection parts 22. Each of the marginal part 21b is of a substantially equilateral triangular shape in plan view. Note that the outer end means an outer end in a surface formed by an X direction and a Y direction. Each of the marginal part 21b is constituted of portions where the later-described openings and pillar parts 24 are connected with the base part 21. A length L1 of one side of the equilateral triangle which defines the outer end of each of the projection parts 22 is, for example, several tens of mm to several hundreds of mm and is determined in accordance with rigidity which is required of the panel structure 1.

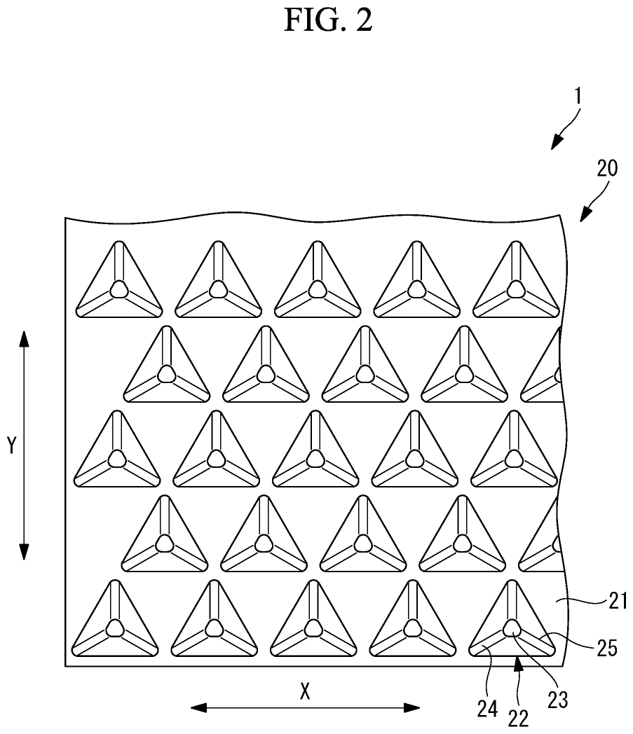

The plurality of projection parts 22 are arranged such that rows of the projection parts are arranged at equal intervals, with each of the rows disposed in one direction (an X direction in FIG. 1 and FIG. 2) and a plurality of these rows are arranged, with each of the rows disposed in a direction (a Y direction in FIG. 1 and FIG. 2) intersecting the one direction. In addition, the projection parts 22 are arranged in a zigzag manner such that positions of projection parts 22 neighboring each other are shifted to each other. The stiffening panel 20 (the base part 21 and the projection parts 22) are formed by subjecting the tabular metal plate to press working. The details of a method of forming the projection parts 22 will be described later.

Next, a shape of each of the projection parts 22 will be described. Since the shapes of the projection parts 22 are the same as one another, a shape of one of the projection parts 22 will be described below as a representative.

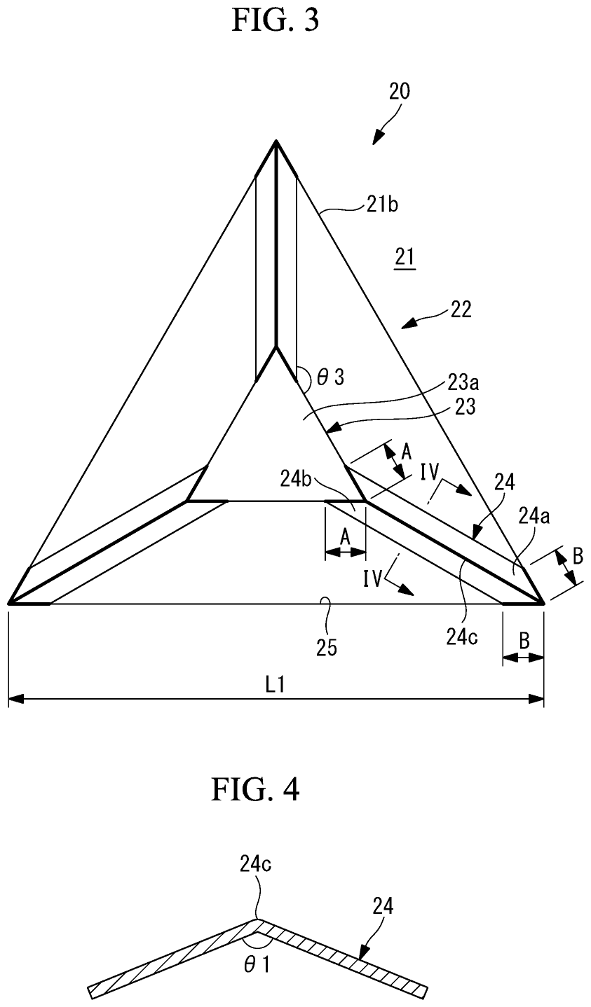

As shown in FIG. 3, the projection part 22 integrally has a top end plate part (joining part) 23 which is joined to one surface of the plate surface of the stiffened panel 10 and three pillar parts (connecting parts) 24 which connect the top end plate part 23 and the base part 21. The projection part 22 is formed by subjecting the tabular metal plate to the press working as described above. Therefore, an inside of the projection part 22 is hollow, and an inner space is formed therein. This inner space communicates with an outer space outside the projection part 22 by the later-described openings 25.

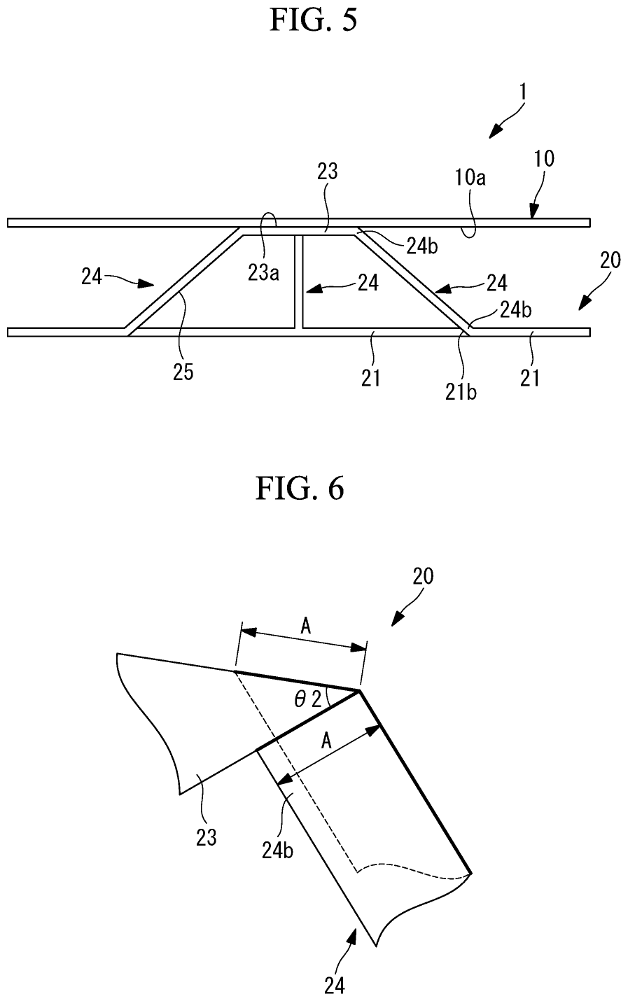

The top end plate part 23 is a platy member which is disposed substantially in parallel with the base part 21. The top end plate part 23 is formed in a substantially equilateral triangular shape having three apices in plan view. One surface (hereinafter, referred to as a “joining surface 23a”) of the plate surface of the top end plate part 23 is in surface-contact with the one surface 10a of the stiffened panel 10 (see FIG. 5). In addition, the joining surface 23a of the top end plate part 23 is joined to the one surface 10a of the stiffened panel 10.

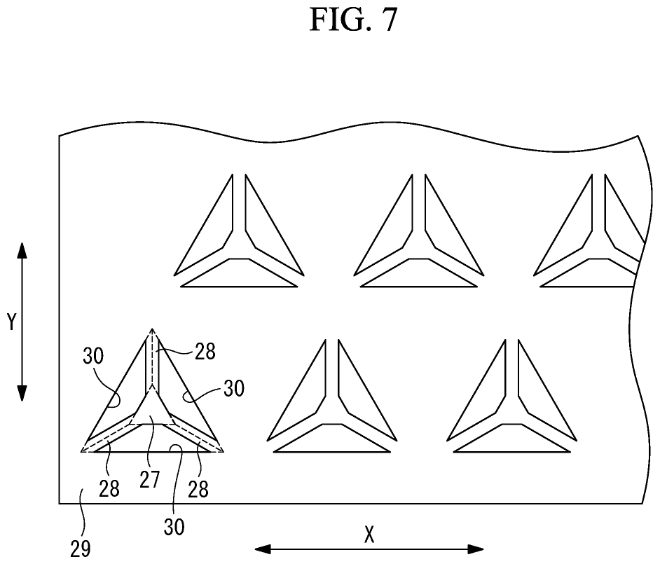

Next, with reference to FIG. 3 to FIG. 6, the pillar parts 24 will be described. Each of the three pillar parts 24 is connected to each corresponding apex of the top end plate part 23. In addition, the three pillar parts 24 are separated from one another in a peripheral direction of the top end plate part 23. In addition, the three pillar parts 24 are inclined from one end thereof toward another end thereof in such a way as to approach another of the pillar parts 24. Since shapes of the pillar parts 24 are the same as one another, one of the pillar parts 24 will be described below as a representative. In addition, in FIG. 3 and FIG. 6, thick lined portions indicate bent portions.

As shown in FIG. 5, the pillar part 24 is a platy member which is bent from the marginal part 21b of the base part 21 and extends toward the joining surface 23a. In other words, one end part 24a of the pillar part 24 in a predetermined direction connects to the marginal part 21b of the base part 21. Specifically, as shown in FIG. 3, the one end part 24a of the pillar part 24 connects to connecting areas B including an apex in the marginal part 21b. The connecting areas B are areas in portions of side portions of the marginal part 21b, which sandwich the apex. Specifically, each of the connecting areas B is provided in a range closer to an apex side than a midpoint of each of the side portions. In other words, each of the connecting areas B is separated from each of connecting areas of a neighboring pillar part 24 and the base part 21.

In addition, as shown in FIG. 5 and FIG. 6, the pillar part 24 is bent from an outer edge of the top end plate part 23 and extends toward the base part 21. In other words, another end part 24b of the pillar part 24 in a predetermined direction connects to an outer edge of the top end plate part 23. Specifically, as shown in FIG. 3 and FIG. 6, the other end part 24b of the pillar part 24 connects to connecting areas A including an apex in an outer edge of the top end plate part 23. The connecting areas A are areas in portions of side portions of the top end plate part 23, which sandwich the apex. Specifically, each of the connecting areas A is provided in a range closer to an apex side than a midpoint of each of the side portions. In other words, each of the connecting areas A is separated from each of connecting areas of a neighboring pillar part 24 and the top end plate part 23.

In addition, as shown in FIG. 3, FIG. 4 and FIG. 6, a cross-sectional shape of the pillar part 24 in a predetermined direction is bent. Specifically, the cross-sectional shape of the pillar part 24 in the predetermined direction is bent in such a way as to project in an outside direction of each of the projection parts 22 in one portion of a substantially central area. The bent part 24c is formed over the whole area in the predetermined direction. Angles θ1 formed at the bent parts 24c may be uniformly the same as one another in predetermined directions and may be changed depending on positions in the predetermined directions. In an example shown in FIG. 3 and FIG. 4, the pillar part 24 is formed such that each of the angles θ1 of the bent parts 24c in middle positions in the predetermined direction is larger than each of angles θ2 of the bent parts 24c (which is approximately 60 degrees and see FIG. 6.) at the end part in the predetermined direction.

As describe above, the three pillar parts 24 are separated from one another in the peripheral direction of the top end plate part 23. Between the neighboring pillar parts 24, as shown in FIG. 3, the three openings 25 are formed. Since shapes of the openings 25 are the same as one another, one of the openings 25 will be described below as a representative.

The opening 25 is formed in a trapezoidal shape in plan view and side view. The opening 25 is defined by the top end plate part 23, the pillar parts 24, and the marginal part 21b. Specifically, a short side of the opening 25 is defined by portions other than the connecting areas A in the outer edge of the top end plate part 23. A long side of the opening 25 is defined by portions other than the connecting areas B in the marginal part 21b of the base part 21. Both oblique sides of the opening 25 are defined by the neighboring pillar parts 24.

Next, a method for manufacturing the panel structure 1 will be described with reference to FIG. 7 and the like.

First, a tabular metal plate member 29 is prepared. Next, as shown in in FIG. 7, trapezoidal shaped through-holes 30 are formed on the metal plate member 29 (opening forming step). The through-holes 30 are portions which become the openings 25 in the stiffening panel 20 after completion. Therefore, the through-holes 30 are formed to have the same shapes as those of the above-described openings 25. In addition, three through-holes 30 are formed in proximity to one another. The three through-holes 30 are arranged in a peripheral direction such that oblique sides thereof are substantially in parallel with each other. These three through-holes 30 become the three openings 25 included in one of the projection parts 22 in the stiffening panel 20 after completion. Hereinafter, the three through-holes 30 arranged in proximity to one another are referred to as a “through-hole set”. The through-hole set is formed in such as a way as to be arranged in a row in the X direction at equal intervals. In addition, the plurality of these rows are arranged in the Y direction. In addition, the through-hole sets are disposed in a zigzag manner such that positions of the through-hole sets of the neighboring rows are shifted to each other. In other words, the through-hole sets are formed in such a way as to correspond to the projection parts 22 in the stiffening panel 20 after completion.

A portion surrounded by short sides of the three through-holes 30 becomes the top end plate part 23 on the stiffening panel 20 after completion. Hereinafter, the portion which becomes the top end plate part 23 on the stiffening panel 20 after completion is referred to as a top end plate corresponding part 27. In addition, portions between oblique sides of the neighboring through-holes 30 become the pillar parts 24 in the stiffening panel 20 after completion. Hereinafter, the portions which become the pillar parts 24 on the stiffening panel 20 after completion are referred to as pillar corresponding parts 28.

Next, the metal plate member 29 having the through-holes 30 formed thereon is subjected to press working by using a press working machine (press working step). The press working machine performs the press working by a die corresponding to the stiffening panel 20. By subjecting the metal plate member 29 to the press working, portions and the like where the top end plate corresponding parts 27 and the pillar corresponding parts 28 are connected are bent, whereby the top end plate corresponding parts 27 become the top end plate parts 23 and the pillar corresponding parts 28 become the pillar parts 24. Thus, the stiffening panel 20 having the above-described shape is molded (see FIG. 2). Note that broken lines in FIG. 7 indicate portions which are bent by performing the press working.

Next, the joining surfaces 23a of the top end plate parts 23 of the stiffening panel 20 are joined to the one surface of the stiffened panel 10. A method of joining the top end plate parts 23 and the stiffened panel 10 is not particularly limited. Joining may be made by using an adhesive or by performing welding.

All of the joining surfaces 23a of the top end plate parts 23 and the stiffened panel 10 are joined, thereby completing manufacturing of the panel structure 1.

The completed panel structure 1 is appropriately applied to an application destination such as a wall member of a tank. Note that when the panel structure 1 is applied to the wall member of the tank or the like, the panel structure 1 may be applied thereto such that the stiffening panel 20 is located inside the tank and the panel structure 1 may be applied thereto such that the stiffening panel 20 is located outside the tank.

According to the present embodiment, the below-described operation and effect are exhibited.

In the present embodiment, the stiffened panel 10 and the stiffening panel 20 are joined, and one part of the stiffening panel 20 (the pillar parts 24 and the base part 21) is provided in such a way as to be separated from the stiffened panel 10. Thus, the stiffening panel 20 serves as ribs which reinforce the stiffened panel 10. Accordingly, rigidity of the whole panel structure 1 can be enhanced.

In the present embodiment, the stiffened panel 10 and the top end plate parts 23 of the stiffening panel 20 are joined. In addition, the top end plate parts 23 and the base part 21 are connected by the pillar parts 24. In other words, the pillar parts 24 support the stiffened panel 10 and the base part 21, thereby maintaining a state in which the stiffened panel 10 and the base part 21 are separated from each other. In the present embodiment, the cross-sectional shapes of the pillar parts 24 are bent. Therefore, rigidity of the pillar parts 24 can be enhanced. Thus, the state in which the stiffened panel 10 and the base part 21 are separated from each other can be suitably maintained. Accordingly, rigidity of the whole panel structure 1 can be further enhanced.

In particular, in the present embodiment, each of the top end plate parts 23 is of the equilateral triangular shape in plan view. When a load is exerted on the stiffened panel 10, the load is inputted from the stiffened panel 10 to the top end plate parts 23 of the stiffening panel 20. The load inputted to the top end plate parts 23 is inputted to the base part 21 via the pillar parts 24. When the load is inputted from the top end plate part 23 to the base part 21, stress is concentrated on apices of the triangular top end plate parts 23. In the present embodiment, since the pillar parts 24 are connected to the apices of the top end plate parts 23, the apices on which the stress is concentrated can be reinforced by the pillar parts 24. Thus, rigidity of the whole panel structure 1 can be enhanced.

In the present embodiment, the openings 25 are formed between the plurality of pillar parts 24. Thus, as compared with a structure in which the openings 25 are not formed, a weight of the panel structure 1 can be reduced.

In addition, in the present embodiment, the openings 25 (through-holes 30) are formed on the tabular metal plate member 29 and thereafter, the press working is performed, thereby molding the stiffening panel 20. Thus, since as compared with a case in which a metal plate member having no openings 25 formed thereon is subjected to the press working, a plasticized area becomes small, energy required for the press working can be reduced. Thus, the panel structure 1 can be easily manufactured. In addition, since the plasticized area is small, a plate thickness can be easily increased, thereby allowing stiffening effect to be easily enhanced.

Note that the case in which the plate member having no openings 25 formed thereon is subjected to the press working is, for example, a case in which a panel structure 1 including a stiffening panel 20 having no openings 25 formed thereon is manufactured, a case in which the press working is performed and thereafter, openings 25 are formed, thereby manufacturing a panel structure 1, or the like.

In the present embodiment, the openings 25 are formed between the pillar parts 24 which are connected to the apices of the top end plate parts 23. In other words, the openings 25 are formed in portions corresponding to side surfaces of the triangular pyramid trapezoid.

Owing to the analysis and examination conducted by the inventors, it has been found out that when a load such as an inner pressure, an axial force, and a shear force is exerted on the panel structure 1 constituted of the stiffened panel 10 and the stiffening panel 20, the panel structure 1 withstands the load mainly by the stiffened panel 10 and the base part 21 of the stiffening panel 20. Note that this stiffening panel 20 has the base part 21 which is separated from the stiffened panel 10 and the truncated pyramids which are provided between the base part 21 and the stiffened panel 10. Thus, it has been found out that it is sufficient for the truncated pyramids to have rigidity with which the state in which the stiffened panel 10 and the base part 21 are separated from each other is maintained.

In addition, owing to the analysis and examination, it has been found out that a degree of contribution, to the load, made by the wall member corresponding to side surfaces of the truncated pyramids provided between the stiffened panel 10 and the base part 21 of the stiffening panel 20 is lower than that of the pillar parts corresponding to side portions of the truncated pyramids. Accordingly, as in the present embodiment, it has been found out that even in a case in which the openings 25 are formed in portions corresponding to the side surfaces of the triangular pyramid trapezoids, the structure having appropriate rigidity can be formed, and as described above, the state in which the stiffened panel 10 and the base part 21 are separated from each other can be suitably maintained.

As described above, in the present embodiment, the openings 25 are formed on the stiffening panel 20, thereby allowing a reduction in weight of the panel structure 1 to be achieved, enjoying effect to easily manufacture the panel structure 1, and enabling a reduction in rigidity of the panel structure 1 to be inhibited. In addition, since by bending the cross-sectional shapes of the pillar parts 24, the rigidity is enhanced, rigidity of the whole panel structure 1 can be enhanced.

In addition, as described above, since the rigidity can be enhanced by the pillar parts 24, it is not required to fill a space between the stiffening panel 20 and the stiffened panel 10 with, for example, mortar or the like for enhancing the rigidity. Thus, a reduction in weight can be devised and costs can be reduced.

Note that the present disclosure is not limited to the above-described embodiment and is modified as appropriate without departing from the scope thereof. Hereinafter, several modifications of the above-described embodiment will be described. Note that in the description of each of the modifications, points which are different from those in the above-described embodiment are described, the same components as those in the above-described embodiment are denoted by the same reference signs, and the detailed description therefor is omitted.

[Modification 1]

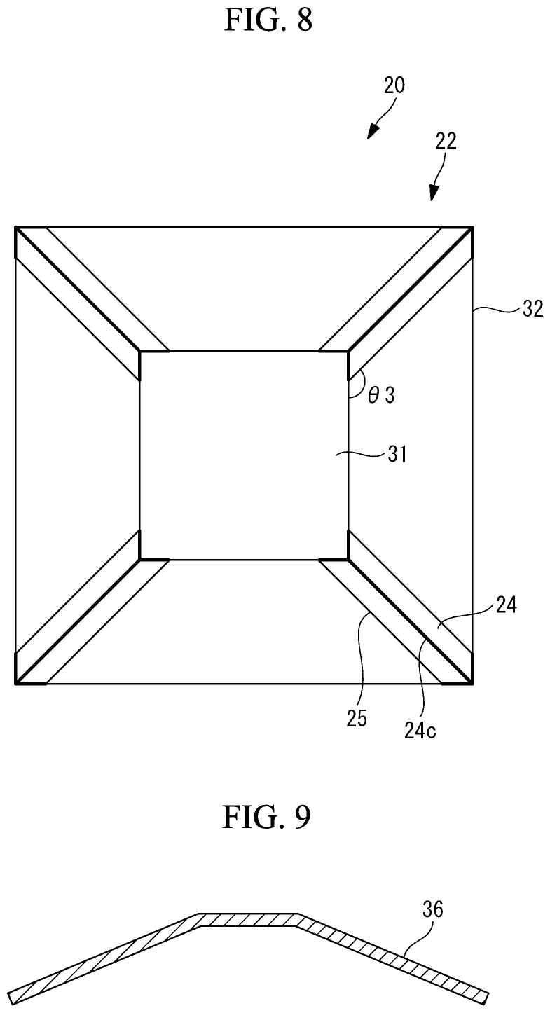

For example, although in the above-described embodiment, the example in which the top end plate parts 23 and the marginal part 21b of the base part 21 are formed each in the equilateral triangular shape in plan view is described, the present disclosure is not limited thereto. For example, as shown in FIG. 8, the top end plate parts 31 and the marginal parts 32 of the base part 21 may be formed each in a square shape in plan view. In other words, an external shape of each of the projection parts 22 may be formed in a square pyramid shape. In this case, the number of apices of each of the top end plate parts 31 and the number of apices of each of the marginal parts 32 are each four. Consequently, the number of the pillar parts 24 is also four, which is the same number as the above-mentioned number. Note that the shape of each of the top end plate parts and each of the marginal parts are not limited to the equilateral triangular shape and the square shape. For example, a shape of each of the top end plate parts and a shape of each of the marginal parts may be a regular polygonal shape such as a regular pentagonal shape and a regular hexagonal shape in plan view. In addition, the shape of each of the top end plate parts and the shape of each of the marginal parts may be a circular shape in plan view. In addition, the shape of each of the top end plate parts and the shape of each of the marginal parts may be a polygonal shape whose lengths of sides are different from one another. Even in the above-described configurations, effect which is the same as that in the above-described embodiment can be obtained.

Note that the number of the apices of the top end plate parts and the number of the apices of the marginal parts (the number of pillar parts) may be determined in accordance with rigidity or the like of the panel structure 1. When the number of the pillar parts is increased, rigidity of the panel structure 1 is enhanced. In addition, when the number of the pillar parts is increased, since an angle θ3 (see FIG. 3 and FIG. 8) formed between each of the top end plate parts and each of the pillar parts, as viewed in plan view, becomes small, workability is enhanced. On the other hand, when the number of the pillar parts is increased, although a weight is increased by that increase in the number thereof and the number of the openings is increased, since rigidity is also increased, an advantage, in that a plate thickness can be reduced, or the like is also exhibited. Accordingly, it is desirable that in consideration of rigidity and a weight which are required of a panel structure 1 to be manufactured, the number of the pillar parts is made to be an appropriate number. Furthermore, it is not required for one stiffening panel to include projection parts whose each shape is one kind of a shape, and no problem arises even when the stiffening panel includes projection parts whose shapes are a plurality of kinds of shapes. In other words, when high strength and high rigidity are required only in specific portions of the panel structure 1, needless to say, a structure of projection parts which satisfies the requirements only for the specific portions may be employed.

[Modification 2]

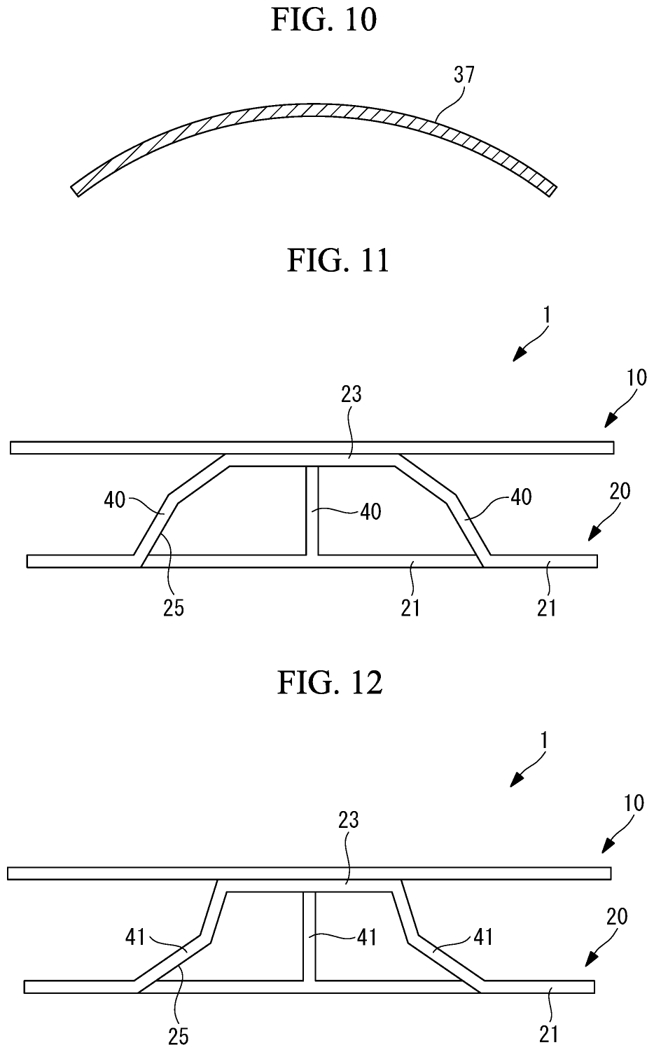

In addition, although in the above-described embodiment, the example in which each of the pillar parts 24 is bent in one portion of the substantially central area in the cross-sectional shape in the predetermined direction in such a way as to project in the outside direction of each of the projection parts 22 is described, the present disclosure is not limited thereto. For example, as with each of pillar parts 36 shown in FIG. 9, each of the pillar parts may be bent in two portions of the substantially central area in the cross-sectional shape in the predetermined direction in such a way as to project in the outside direction of each of the projection parts 22. In addition, as with each of pillar parts 37 shown in FIG. 10, each of the pillar parts may be curved in the cross-sectional shape in the predetermined direction in such a way as to project in the outside direction over substantially the whole area of each thereof. Even in the above-mentioned shape of each thereof, rigidity of the pillar parts can be enhanced.

[Modification 3]

In addition, although in the above-described embodiment, the example in which each of the pillar parts 24 is formed in a linear shape along the predetermined direction is described, the present disclosure is not limited thereto.

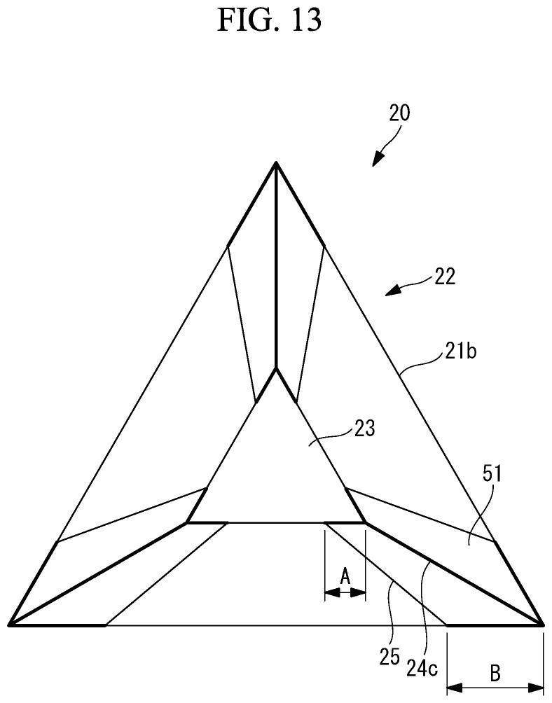

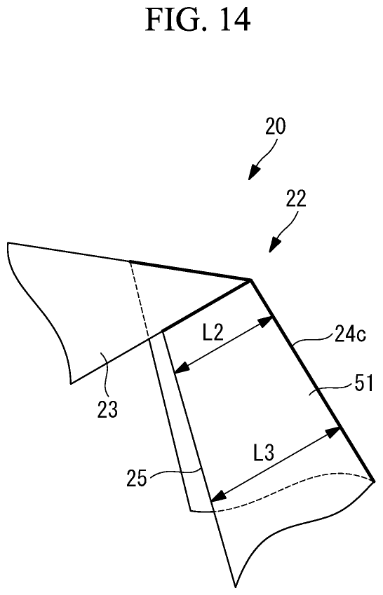

For example, as with each of pillar parts 40 shown in FIG. 11, each of the pillar parts may be bent in such a way as to project in a substantially central portion in the predetermined direction in an outside direction of each of the projection parts 22 as with each of the pillar part 37 shown in FIG. 10. In addition, as with each of pillar parts 41 shown in FIG. 12, each of the pillar parts may be bent in such a way as to project in the substantially central portion in the predetermined direction in an inside direction of each thereof.

[Modification 4]

In addition, although in the above-described embodiment, the example in which a width of each of the pillar parts 24 has a uniform length in the predetermined direction is described, the present disclosure is not limited thereto. For example, as with each of the pillar parts 51 shown in FIG. 13 and FIG. 14, the width of each of the pillar parts may vary depending on positions in the predetermined direction. In an example shown in FIG. 13 and FIG. 14, the width of each of the pillar parts 51 becomes longer in accordance with an increase in proximity to each of the marginal part 21b from each of the top end plate parts 23. In other words, as shown in FIG. 14, a length L3 of a width on a side of each of the marginal part 21b is longer than a length L2 of a width on a side of each of the top end plate parts 23. In addition, as shown in FIG. 13, a length of each of the connecting areas B is longer than a length of each of the connecting areas A. The above-described configuration is employed, thereby allowing rigidity of the pillar parts to be enhanced.

[Modification 5]

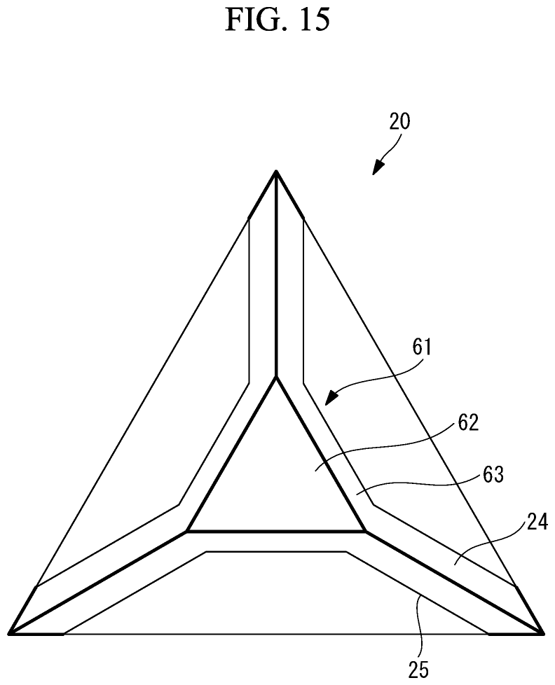

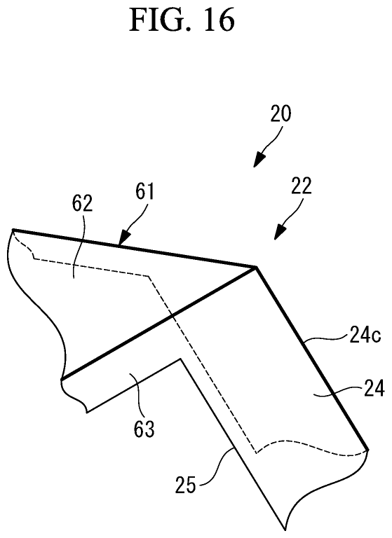

In addition, as shown in FIG. 15 and FIG. 16, flange parts 63 may be provided. Each of the top end plate parts 61 in the present embodiment has a flat plate part 62 corresponding to each of the top end plate parts 23 in the above-described embodiment and each of the flange parts 63, which is bent from substantially the whole area of an outer peripheral end of each of the flat plate parts 62 and extends in a direction toward the base part 21. Another end part 24b of each of the pillar parts 24 is connected to each of the flange parts 63. Since each of the flange parts 63 is formed in substantially the whole area of the outer peripheral end of each of the flat plate parts 62, of course, a length of each of the flange parts 63 in a peripheral direction is longer than a length (width) of each of the pillar parts 24 in the peripheral direction. In addition, each of the flange parts 63 and each of the pillar parts 24 are disposed such that plate surfaces thereof are flush with each other.

In the configuration described above, a part of connecting each of the flat plate parts 62 and each of the flange parts 63 becomes a bent part. Since each of the flange parts 63 is connected to the whole area of each of the flat plate parts 62 in the peripheral direction, local bending can be inhibited. Thus, the pillar parts 24 can be solidly connected to the top end plate parts 23. Hence, rigidity of the whole panel structure 1 can be enhanced.

The panel structure and the method for manufacturing the panel structure described in the present embodiment hereinbefore can be comprehended, for example, as follows.

The panel structure according to a first aspect of the present disclosure includes: the first panel (10) and the second panel (20) which is joined to the first panel (10). The second panel (20) integrally has: the joining parts (23) which are joined to the plate surface (10a) of the first panel (10); the base part (21) which is separated from the plate surface (10a) of the first panel (10) and faces the plate surface (10a); and the plurality of connecting parts (24) which connect the base part (21) and the joining parts (23). The one end part (24a) of each of the connecting parts (24) connects to the base part (21), another end part (24b) connects to each of the joining parts (23), the cross-sectional shape of each of the connecting parts in a direction from the one end part (24a) toward the other end part (24b) is bent or curved, and between the connecting parts (24) neighboring each other, the openings (25) are formed.

In the above-described configuration, the first panel and the second panel are joined, and one part of the second panel (the connecting parts and the base part) are provided in such a way as to be separated from the first panel. Thus, the second panel serves as ribs for reinforcing the first panel. Accordingly, rigidity of the whole panel structure can be enhanced.

In the above-described configuration, the first panel and the joining parts of the second panel are joined. In addition, the joining parts and the base part are connected by the connecting parts. In other words, the connecting parts support the first panel and the base part, thereby maintaining the state in which the first panel and the base part are separated from each other. In the above-described configuration, the cross-sectional shape of each of the connecting parts is bent or curved. Therefore, rigidity of the connecting parts can be enhanced. Consequently, the state in which the first panel and the base part are separated from each other can be suitably maintained. Accordingly, rigidity of the whole panel structure can be further enhanced.

In the above-described configuration, between the plurality of connecting parts, the openings are formed. Thus, as compared with the structure having no openings formed thereon, the reduction in weight of the panel structure can be made. In addition, for example, when the plate member having the openings formed thereon is subjected to the press working, thereby molding the second panel, energy required for the press working can be reduced, as compared with a case in which a plate member having no openings formed thereon is subjected to the press working.

In addition, the panel structure according to a second aspect is the panel structure according to the first aspect in which each of the joining parts (23) is of the polygonal shape having the plurality of apices, when the plate surface is viewed, and the connecting parts (24) are connected to the apices of each of the joining parts (23).

In the above-described configuration, when the load is exerted on the first panel, the load is inputted from the first panel to the joining parts of the second panel. The load inputted to the joining parts is inputted to the base part via the connecting parts. When the load is inputted from the joining parts to the base part, the stress is concentrated on the apices of each of the joining parts, which is of the polygonal shape. In the above-described configuration, since the connecting parts are connected to the apices of each of the joining parts, the apices on which the stress is concentrated can be reinforced by the connecting parts. Thus, rigidity of the whole panel structure can be enhanced.

In addition, the panel structure according to a third aspect is the panel structure according to the first aspect or the second aspect in which the joining parts (23) include the flange parts (63) of each of the joining parts bending from the edge and extending in a direction toward the base part (21), the connecting parts (24) are connected to the flange parts (63), the length of each of the flange parts (63) in the peripheral direction of each of the joining parts (23) is longer than the length of each of the connecting parts (24) in the peripheral direction.

In the above-described configuration, the flange parts and the connecting parts are connected to each other. The length of each of the flange parts in the peripheral direction of each of the joining parts is longer than the length of each of the connecting parts in the peripheral direction. Thus, the connecting parts can be solidly connected to the joining part. Thus, rigidity of the whole panel structure can be enhanced.

The method for manufacturing a panel structure according to a first aspect of the present disclosure is the method for manufacturing the panel structure (1) which includes the first panel (10) and the second panel (20) which is joined to the first panel (10). The second panel (20) integrally has: the joining parts (23) which are joined to the plate surface of the first panel (10); the base part (21) which is separated from the plate surface of the first panel (10) and faces the plate surface; and the plurality of connecting parts (24) which connect the base part (21) and the joining parts (23). The one end part (24a) of each of the connecting parts (24) connects to the base part (21), another end part (24b) connects to each of the joining parts (23), the cross-sectional shape in a direction from the one end part (24a) toward the other end part (24b) is bent or curved, and between the connecting parts (24) neighboring each other, the openings (25) are formed. The method includes: the opening forming step of forming the openings (25) on the tabular member; the press working step of subjecting the member having the openings (25) formed thereon in the opening forming step to the press working, thereby molding the second panel (20); and the joining step of joining the joining part (23) of the second panel (20) molded in the press working step and the plate surface of the first panel (10).

In the above-described configuration, the cross-sectional shape of each of the connecting parts is bent or curved. Therefore, rigidity of the connecting parts can be enhanced. Thus, the state in which the first panel and the base part are separated from each other can be suitably maintained. Accordingly, the panel structure whose whole rigidity is further enhanced can be manufactured.

In the above-described configuration, the openings are formed on the tabular member and thereafter, the press working is performed, thereby molding the second panel. Thus, as compared with the case in which the plate member having no openings formed thereon is subjected to the press working, since the plasticized area becomes small, the energy required for the press working can be reduced. Thus, manufacturing thereof can be facilitated. Note that the case in which the plate member having no openings formed thereon is subjected to the press working is, for example, the case in which a panel structure including the panel having no openings formed thereon is manufactured, the case in which the press working is performed and thereafter, the openings are formed, thereby manufacturing the panel structure, or the like.

### REFERENCE SIGNS LIST

1: Panel structure

10: Stiffened panel (First panel)

10a: One surface (Plate surface)

20: Stiffening panel (Second panel)

21: Base part

21b: Marginal part

22: Projection part

23: Top end plate part (Joining part)

23a: Joining surface

24: Pillar part (Connecting part)

24a: One end part

24b: Another end part

24c: Bent part

25: Opening

27: Top end plate corresponding part

28: Pillar corresponding part

29: Metal plate member

30: Through-hole

61: Top end plate part

62: Flat plate part

63: Flange part

What is claimed is:

1. A panel structure comprising:
a first panel; and
a second panel being joined to the first panel, wherein
the second panel integrally has joining parts which are joined to a plate surface of the first panel, a base part which is separated from the plate surface of the first panel and faces the plate surface, and a plurality of connecting parts which connect the base part and the joining parts,
one end part of each of the connecting parts is connected to the base part, another end part of each of the connecting parts is connected to each of the joining parts, and a cross-sectional shape of each of the connecting parts in a direction from the one end part toward the other end part is bent or curved, and
between the connecting parts neighboring each other, openings are formed.

2. The panel structure according to claim 1, wherein each of the joining parts is of a polygonal shape having a plurality of apices when the plate surface is viewed, and
the connecting parts are connected to the apices of each of the joining parts.

3. The panel structure according to claim 1, wherein
each of the joining parts includes flange parts being bent from edges of each of the joining parts and extending in a direction toward the base part, and
each of the connecting parts is connected to each of the flange parts, and
a length of each of the flange parts in a peripheral direction of each of the joining parts is longer than a length of each of the connecting parts in the peripheral direction.

4. The panel structure according to claim 2, wherein
each of the joining parts includes flange parts being bent from edges of each of the joining parts and extending in a direction toward the base part, and
each of the connecting parts is connected to each of the flange parts, and
a length of each of the flange parts in a peripheral direction of each of the joining parts is longer than a length of each of the connecting parts in the peripheral direction.

5. A method for manufacturing a panel structure comprising: a first panel; and a second panel being joined to the first panel, in the panel structure,
the second panel integrally has joining parts which are joined to a plate surface of the first panel, a base part which is separated from the plate surface of the first panel and faces the plate surface, and a plurality of connecting parts which connect the base part and the joining parts,
one end part of each of the connecting parts is connected to the base part, another end part of each of the connecting parts is connected to each of the joining parts, and a cross-sectional shape of each of the connecting parts in a direction from the one end part toward the other end part is bent or curved, and
between the connecting parts neighboring each other, openings are formed, the method comprising:
an opening forming step of forming the openings on a tabular member;
a press working step of subjecting the member having the openings formed in the opening forming step to press working and of molding the second panel; and
a joining step of joining the joining parts of the second panel molded in the press working step and the plate surface of the first panel.
